(19) United States
(12) Patent Application Publication
(10) Pub. No.: US 2016/0313970 A1
(43) Pub. Date: Oct. 27, 2016

(54) GAPLESS MEDIA GENERATION

(71) Applicant: Microsoft Technology Licensing, LLC, Redmond, WA (US)

(72) Inventors: Sumit Malhotra, Bellevue, WA (US); Bala Sivakumar, Sammamish, WA (US); Vlad Alexandrov, Redmond, WA (US); Stephen Estrop, Seattle, WA (US)

(21) Appl. No.: 14/694,948

(22) Filed: Apr. 23, 2015

(51) Int. Cl. G06F 3/16; G06N 99/00

(52) U.S. Cl. CPC G06F 3/165; G06N 99/005

(57) ABSTRACT

A media engine may determine if a received media file is according to a format that includes metadata indicating gap information such as in the header of the file container. If metadata indicating gap information is detected that information may be provided to the media engine by a media file parser and used by the media engine to create a media stream with gap(s) removed based on the metadata. If the received media file does not include metadata indicating gap information, heuristics may be employed to estimate and remove gap(s) in the resulting media stream. The media stream may then be saved or played.

### BACKGROUND

Gapless playback is the uninterrupted playback of consecutive audio tracks such that playback preserves the time distances between tracks in the original audio source. Playback of compressed audio where each track is a discrete file usually results in a small gap between consecutive tracks. The absence of gapless playback is an annoyance to listeners where tracks are meant to segue into each other—usually albums of classical music, electronic music, concept albums and live recordings with audience noise.

Various software, firmware and hardware components may add up a substantial delay associated with starting playback of a track. If not accounted for, the listener may be left waiting in silence as the player fetches the next file, updates metadata, and decodes the whole first block, before having any data to feed the hardware buffer. The gap may be as much as half a second or more in some scenarios, which may be very noticeable in continuous music such as certain classical or dance genres. To account for the whole chain of delays, the start of the next track may be readily decoded before the currently playing track finishes. The two decoded pieces of audio may then be fed to the hardware continuously over the transition, as if the tracks were concatenated in software.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing gapless media for a variety of formats. A media engine may determine if received media is according to a format that includes metadata indicating gap information. If metadata indicating gap information is detected that information is extracted and used to create a media stream with gap(s) removed. If the received media does not include metadata indicating gap information, heuristics may be employed to estimate and remove gap(s) in the resulting media stream. The media stream may then be saved or played.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes example implementation options for a media engine providing gapless media for various formats;

FIG. 2 illustrates how gaps may be introduced into a media stream due to latency;

FIG. 3 illustrates encoder delay and priming in compressed audio formats;

FIG. 4 illustrates overlapping frames of MP3 format;

FIG. 5A and 5B illustrate how overlapping input windows result in windowed and overlapped outputs through transform and inverse transform, and remainder padding;

FIG. 6 illustrates an example media engine processing different inputs;

FIG. 7 is a simplified networked environment, where a system according to embodiments may be implemented;

FIG. 8 is a block diagram of an example computing device, which may be used to implement gapless media for various formats; and

FIG. 9 illustrates a logic flow diagram of a method to provide gapless media for various formats, according to embodiments.

### DETAILED DESCRIPTION

As briefly described above, a media engine may determine if a received media file is according to a format that includes metadata indicating gap information such as in the header of the file container. If metadata indicating gap information is detected that information may be extracted and used to create a media stream with gap(s) removed. If the received media file does not include metadata indicating gap information, heuristics may be employed to estimate and remove gap(s) in the resulting media stream. The media stream may then be saved or played.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide gapless media for various formats. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

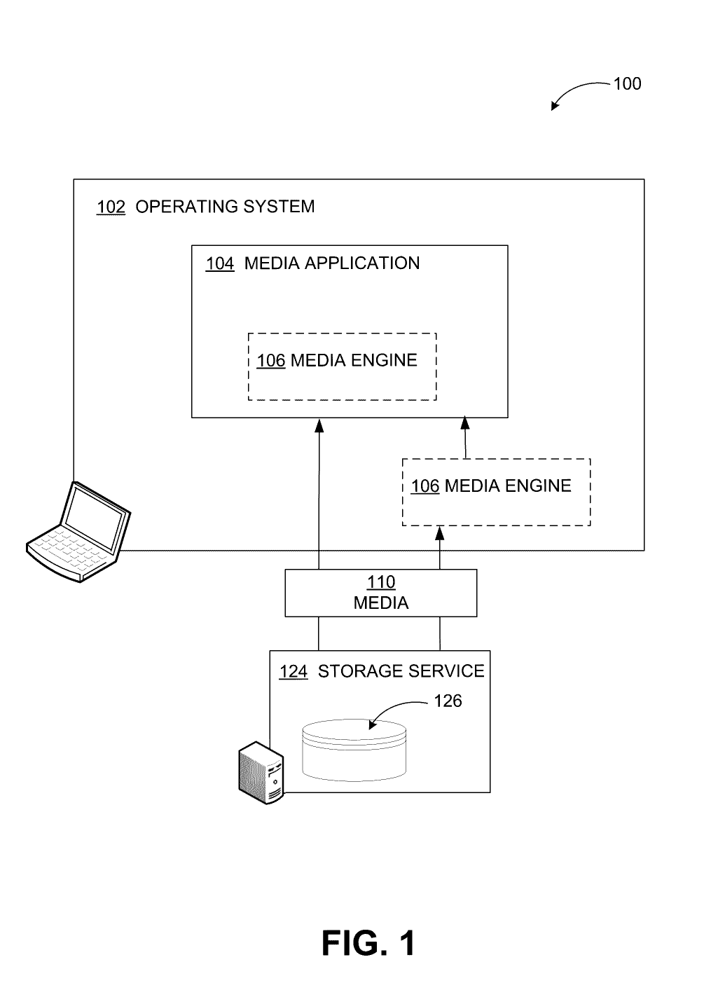

FIG. 1 includes example implementation options for a media engine providing gapless media for various formats.

The example configuration shown in diagram 100 includes a media application 104 executed within an operating system 102 on a computing device. The computing device may be any computing device described herein or similar others. The media application 104 may generate, playback, store, and manage media including audio and/or video media. While embodiments may be applied to video media as well, practical implementation examples are discussed herein using audio media. The media application 104 may receive media files and/or media streams (media 110) from one or more data stores 126 at a storage service 124, for example, cloud storage, media consolidators, personal storage, and so on. The media application 104 may also record media through recording devices integrated or remotely coupled to the computing device.

The media engine 106 may be an integrated part of the media application 104 or an independent module within the operating system 102 and serve multiple media applications. The media engine 106 may determine if received media files are according to a format that includes metadata indicating gap information. If metadata indicating gap information is detected the media engine 106 may extract that information and use to create a media stream with gap(s) removed. If the received media does not include metadata indicating gap information, the media engine 106 may employ heuristics or other machine learning approaches to estimate and remove gap(s) in the resulting media stream. The media engine 106 may then save or play media stream.

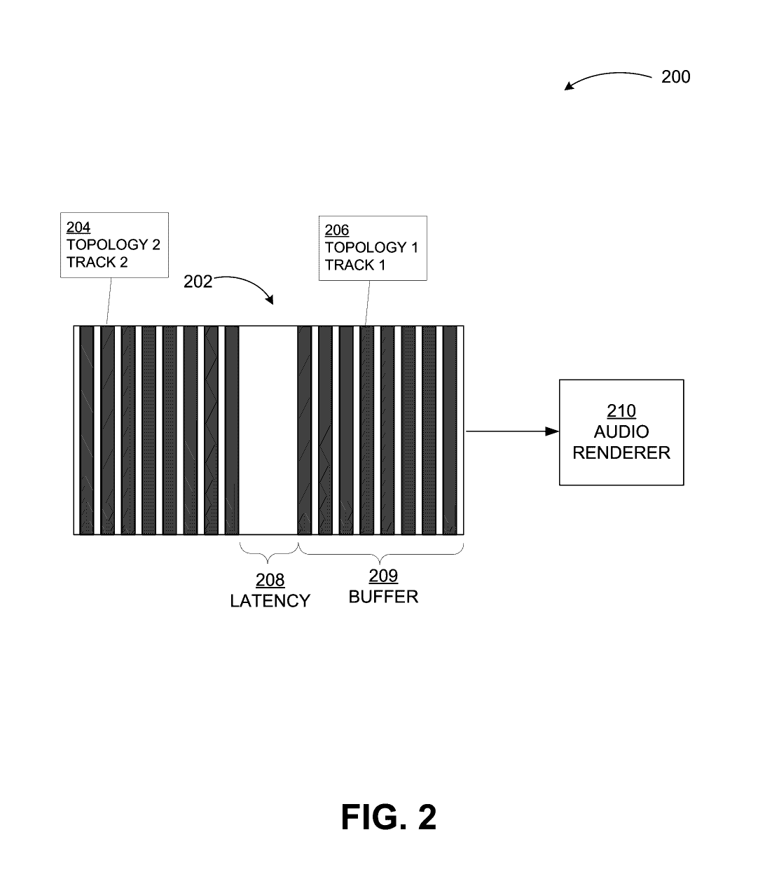

FIG. 2 illustrates how gaps may be introduced into a media stream due to latency.

Gapless media playback is an important feature of modern media players allowing enhanced user experience. In an example scenario, a user may be a fan of Electronic Dance Music (EDM). One aspect of EDM concerts are that they are typically one long party where the music never stops—it simply flows from one song into another, like a river of music. Media players to which the users may listen at work and other places may introduce tiny gaps, pops, and clips between tracks, which may distract the user and degrade the listening experience. A gapless media player may present EDM albums exactly the way they are intended to be heard.

Gaps, however, may be introduced due to a number of reasons. Diagram 200 illustrates one example reason for gaps in media, latency. Furthermore, users may want to play media files from a variety of sources, thus, according to a variety of formats. While conventional media players may be configured to remove gaps in one format, they are typically helpless when other media formats are encountered.

Returning to the latency cause gaps, hardware, software, and firmware components involved in playback may add significant latency to the start of playback of a track. As long as the same audio renderer is utilized, the buffer is continuous. As depicted in the diagram 200, if the duration of the samples from a current track 206 in an audio renderer buffer 202 is greater than the latency 208 in producing samples from the next track 204 to be provided to audio renderer 210, the playback may be seamless without any perceived gaps between tracks. This may be sufficient mitigation for gapless playback in a number of of scenarios (including common network latency involved in fetching tracks), but cannot guarantee gaplessness.

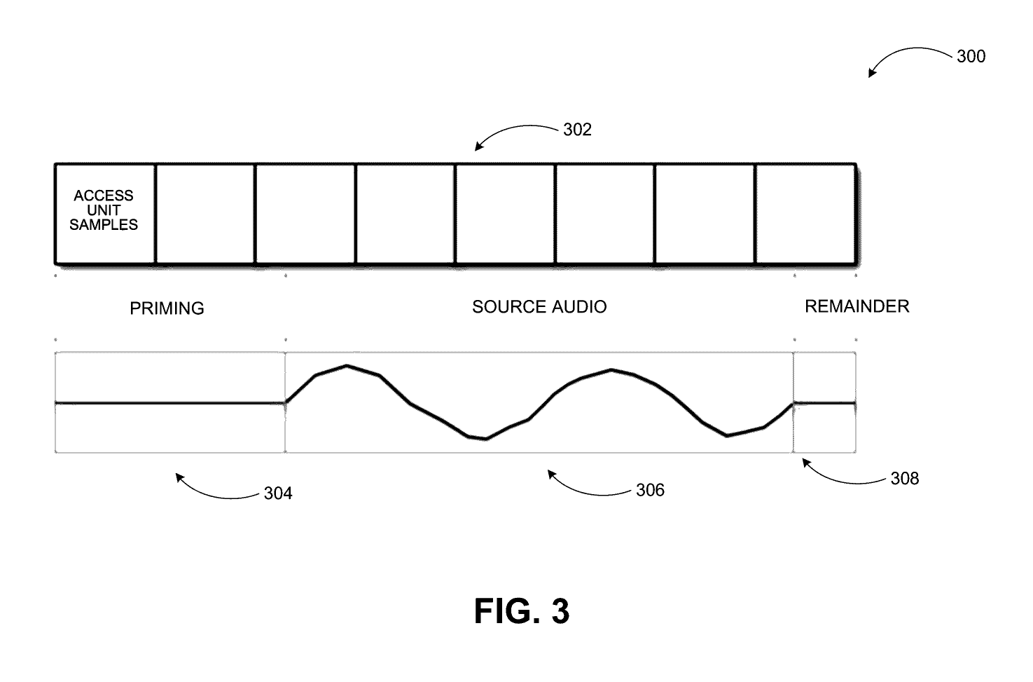

FIG. 3 illustrates encoder delay and priming in compressed audio formats.

Another cause of gaps in media streams may be due to compression of media. Uncompressed data is stored as individual samples and therefore do not have delay or padding within the audio file. However, most audio compression schemes involve a time/frequency domain transform, which may unavoidably introduce some silence at the beginning of the stream. Because transforms are operated on fixed-size blocks, silence data may be appended to the input before the transform at the end of the track. If the amount of encoder delay and padding are not accurately accounted for, the encoded silence may be decoded (and played) along with the audio data, creating gaps at the ends of the track.

Yet another reason for gaps may be creation format of audio disks. Audio CDs can be mastered in Disc-At-Once (DAO) or Track-At-Once (TAO) modes. Optical disks are sometimes recorded in the TAO mode because they are more flexible (allowing data and audio data on the same disk), but insert a gap (˜2 s) at track boundaries.

Some encoding techniques such as advanced audio coding (AAC) require data beyond the source audio samples in order to correctly encode and decode audio samples due to the nature of the encoding algorithm. Such encoding approaches may use a transform over consecutive sets of 2048 audio samples, for example, applied every 1024 audio samples (overlapped). For correct audio to be decoded, both transforms for any period of 1024 audio samples may be needed. For this reason, encoders may add at least 1024 samples of silence before the first ‘true’ audio sample, and often add more. This is called variously “priming”, “priming samples”, or “encoder delay”.

Encoder delay is the delay incurred during encoding to produce properly formed, encoded audio packets. It typically refers to the number of silent media samples (priming samples) added to the front of an encoded bitstream. Decoder delay is the number of “pre-roll” audio samples required to reproduce an encoded source audio signal for a given time index. This number may be algorithmically based. The decoder delay may establish the minimum encoder delay possible (for example, 1024 for AAC). The common practice is to propagate the encoder delay in the AAC bitstream. When these audio packets are then decoded back to the PCM domain, the source waveform represented may be offset in its entirety by this encoder delay amount. Since encoded audio packets hold a fixed number of audio samples (for example, 1024 samples) additional trailing or ‘remainder’ silent samples following the last source sample may be needed so as to pad the final audio packet to the required length.

In diagram 300, the bitstream 302 represents equal-sized packets of an encoded audio bitstream. Portions of the analog signal corresponding to priming 304 source audio 306, and remainder (padding) 308 are shown below the corresponding packets of the bitstream 302.

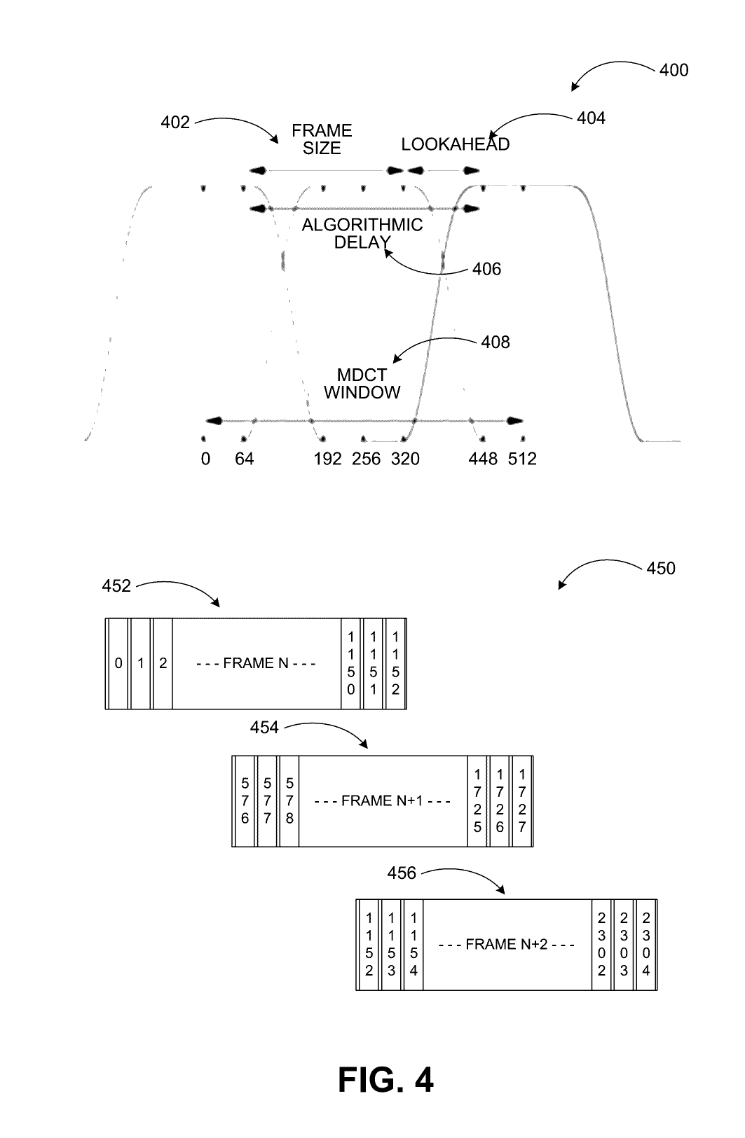

FIG. 4 illustrates overlapping frames of MP3 format.

The modified discrete cosine transform (MDCT) may be employed in many compression formats like MP3, AAC, Vorbis, AC-3, WMA, ATRAC and Cook. The MDCT is a lapped transform—it is designed to be performed on consecutive blocks of a larger dataset, where subsequent blocks are overlapped (e.g., 50% overlap). The MP3 (MPEG1) frame size is 1152 samples/frame. MP3 stores MDCT coefficients which represent 1152 samples, but they are overlapped by 50% as shown in diagram 400. An algorithmic delay 406 may include frame size 402 and lookahead 404. The algorithmic delay 406 may be selected to be smaller than an MDCT window 408.

To complete the frames 450, all data need to be added. The complete frame of samples 576-1727 may need frame N, N+1 and N+2 (452, 454, and 456). Thus, MDCT based encoders may apply silence to the beginning of the audio track to account for overlap and accurately encode the start of the track. Encoder delay, thus, describes the delay incurred at encode to produce properly encoded packets. This is the number of silent sample frames (also called priming frames) added to the front of the encoded bitstream.

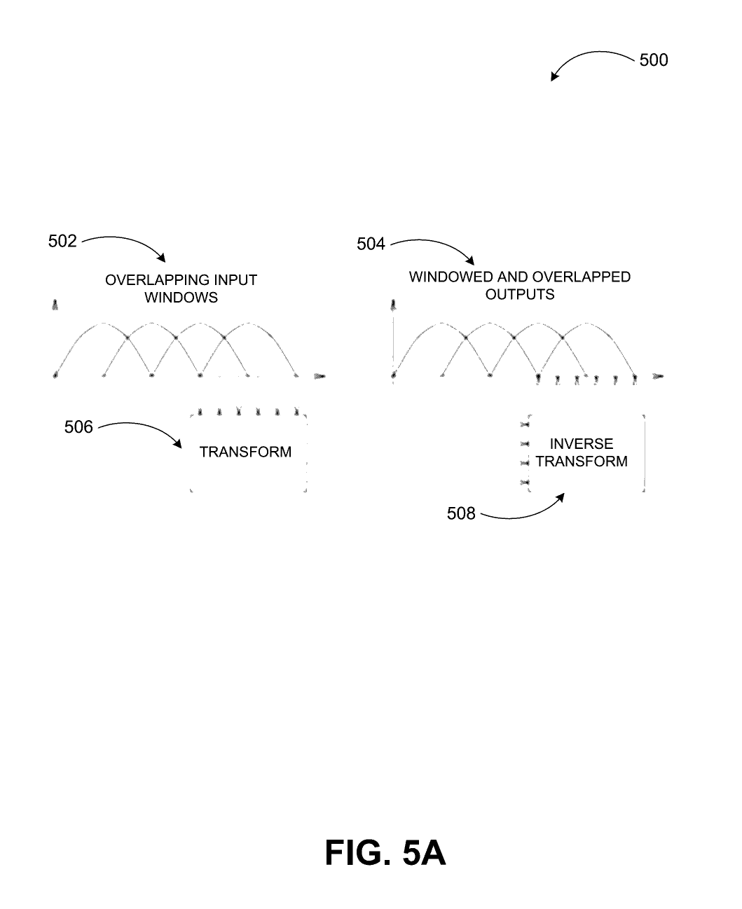

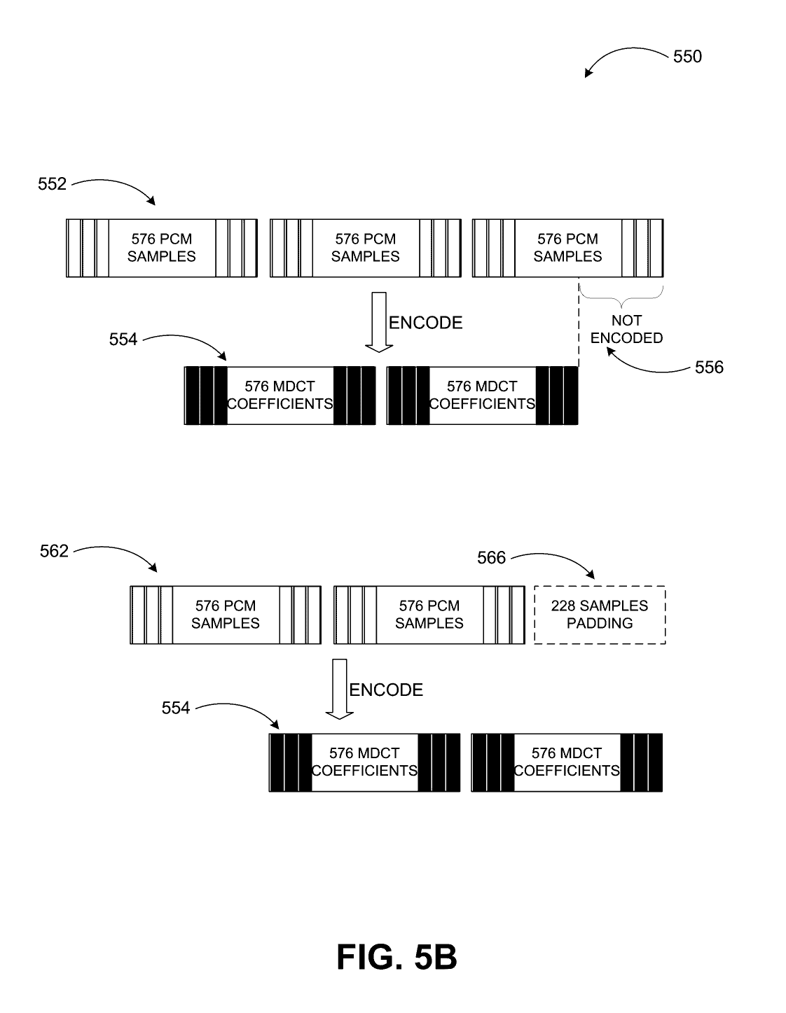

FIG. 5A and 5B illustrate how overlapping input windows result in windowed and overlapped outputs through transform and inverse transform, and remainder padding.

Diagram 500 shows overlapping input windows 502 at encode, where the samples are transformed (506), and windowed and overlapped outputs 504 at decode, where the encoded samples are inverse transformed (508). As mentioned above, the term remainder refers to the number of silent samples (padding) added to the end of the compressed bitstream to round up to the unit/frame size. For MPEG1, frame size=1152 samples/frame. For MPEG2, frame size=576 samples/frame. Because the MDCTs are overlapped, encoding and decoding may need data from multiple frames.

Diagram 550 shows multiple frames of 576 samples (552) according to an example MPEG2 encoding scheme. The resulting MDCT coefficients 554 following the transform may miss samples from the unencoded frames. No matter how the file is truncated, the last 228 (556) samples may not be encoded, for example.

In some implementations, the encoder may append padding 566 to the input file (frames 562) to guarantee all samples to be encoded (MDCT coefficients 554). If the number of samples is not an exact multiple of the frame size, then the last frame of data may be padded with 0's so that it reaches the packet/frame size. The encoder delay and the padding information may be stored as part of the metadata in some media formats, for example, as specified bytes in the header. If a media engine knows which bytes specify the encoder delay and the padding, it may extract that information and use to remove the gap(s) in a media stream resulting from combination of that file with other media files. However, not all media formats define the delay in their metadata, and some may define it, but the location may be unknown to the media engine.

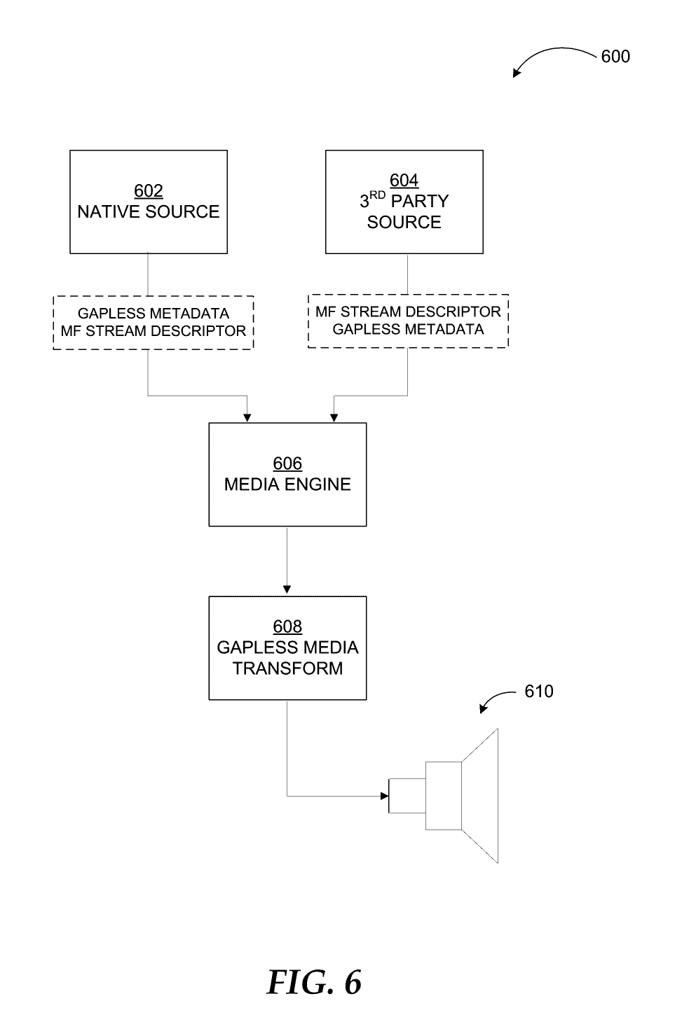

FIG. 6 illustrates an example media engine processing different inputs.

Attributes such as encoder delay and padding may be specified as part of the media stream descriptor in some media formats. Embodiments may take advantage of these values whether they come from a native media source 602 or a third party media source 604 as shown in diagram 600. By implementing a standard input specification to media engine 606, third party developers may be enabled to use media of any source and enable gapless media playback by simply exposing the gap information in the media stream descriptor (metadata). Thus, instead of having to develop or use a proprietary media playback application, the third party developers may interface with the media engine 606 of a platform and enable gapless media transformation 608 and rendering of the gapless media (610).

If the metadata does not include gap information for media from a particular source, the media engine 606 may still be able to remove or reduce the effects of the gap(s) by employing a machine-learning based approach such as heuristics. While the latter may not result in complete removal of gaps all the time, the end result may still be enhanced user experience with a wider range of media sources.

Media engine 606 may create a media playback list including audio/video media playback items, create a media playback list from an existing playlist, bind playlists to a media element for automatic playback, receive events when the media sources and media playback items are opened, receive events when playback has switched from one media playback item to another, and receive error events for specific media playback items in the media playback list. The media engine 606 may also configure loop and shuffle on the media playback list, reference media assets from uniform resource identifier, stream, file, or other sources, and support future extensions of media sources and media playback items for tracks and other metadata. Other functionality typically performed by multimedia applications, such as playback controls, may be performed on the media element after the media playback list has been bound to it.

The examples in FIGS. 1 through 6 have been described using specific media types, encoding schemes, systems, services, applications and processes to provide gapless media for various formats. Embodiments are not limited to the specific network environments, systems, services, applications, and processes according to these examples.

Playing and generating gapless media streams from a variety of media file types may enhance user experience with playback systems and media overall. Enabling removal of distracting gaps in played media may reduce annoyance factor for users while allowing users to generate and playback media streams from any source they wish.

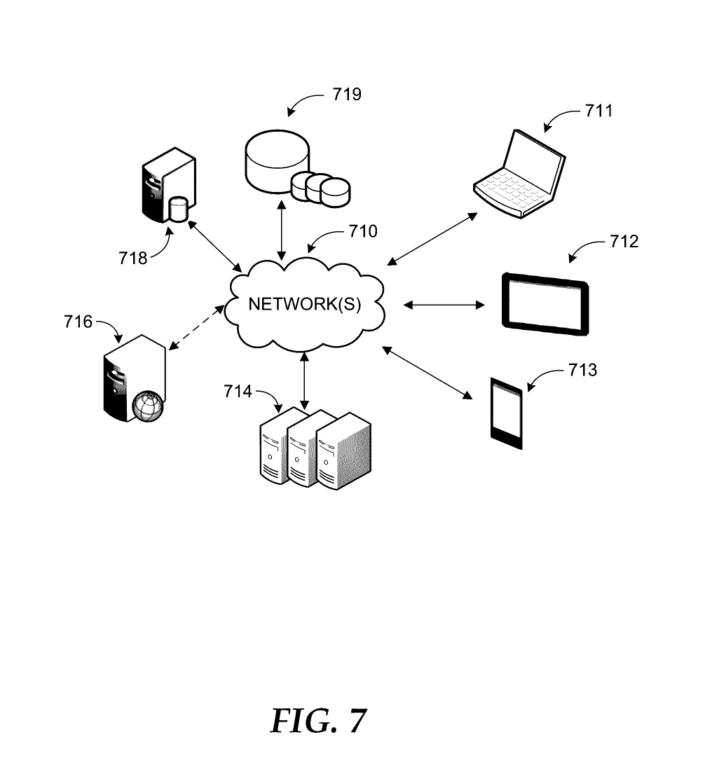

FIG. 7 is an example networked environment, where embodiments may be implemented. A media playback or generation application configured to generate and/or playback gapless media from a variety of source formats may be implemented via software executed over one or more servers 714 such as a hosted service. The platform may communicate with client applications on individual computing devices such as a smart phone 713, a mobile computer 712, or desktop computer 711 (‘client devices’) through network(s) 710.

Client applications executed on any of the client devices 711-713 may facilitate communications via application(s) executed by servers 714, or on individual server 716. The media application may determine if received media is according to a format that includes metadata indicating gap information. If metadata indicating gap information is detected that information may be extracted and used to create a media stream with gap(s) removed. If the received media does not include metadata indicating gap information, heuristics may be employed to estimate and remove gap(s) in the resulting media stream. The media stream may then be saved or played. The media application may store the item in data store(s) 719 directly or through database server 718.

Network(s) 710 may comprise any topology of servers, clients, Internet service providers, and communication media. A system according to embodiments may have a static or dynamic topology. Network(s) 710 may include secure networks such as an enterprise network, an unsecure network such as a wireless open network, or the Internet. Network(s) 710 may also coordinate communication over other networks such as Public Switched Telephone Network (PSTN) or cellular networks. Furthermore, network(s) 710 may include short range wireless networks such as Bluetooth or similar ones. Network(s) 710 provide communication between the nodes described herein. By way of example, and not limitation, network(s) 710 may include wireless media such as acoustic, RF, infrared and other wireless media.

Many other configurations of computing devices, applications, data sources, and data distribution systems may be employed to provide gapless media from various source formats. Furthermore, the networked environments discussed in FIG. 7 are for illustration purposes only. Embodiments are not limited to the example applications, modules, or processes.

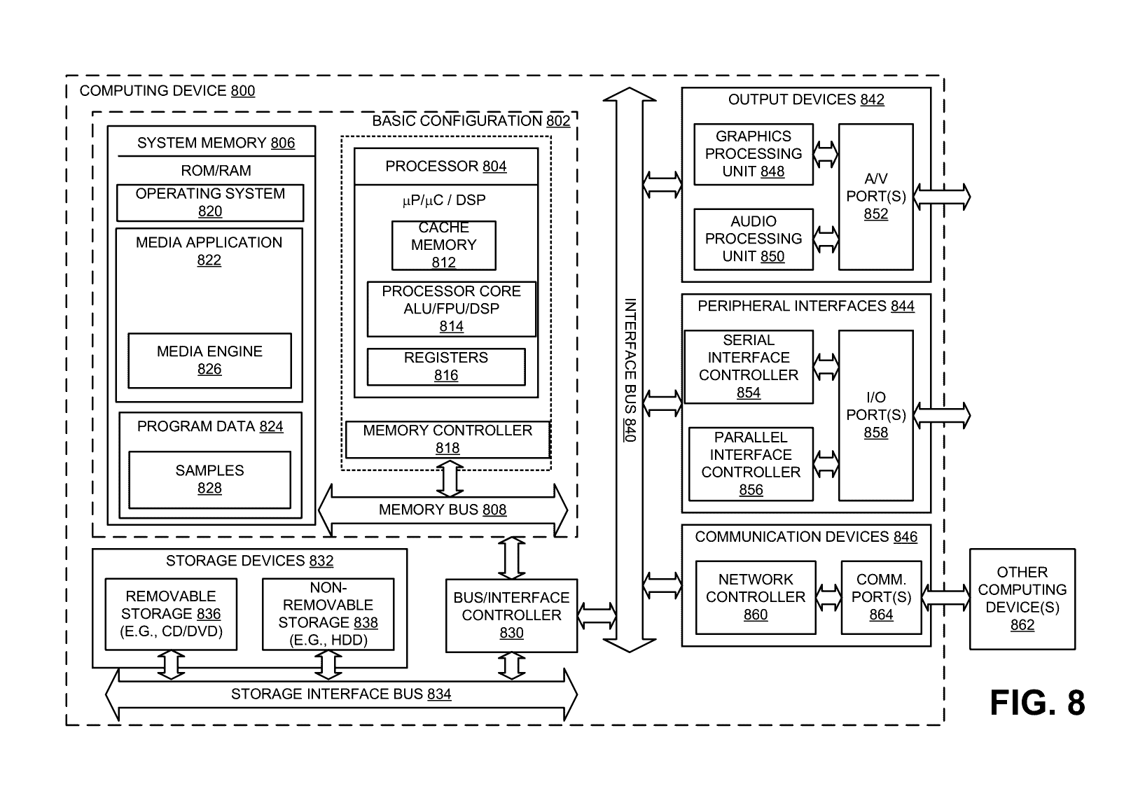

FIG. 8 and the associated discussion are intended to provide a brief, general description of a general purpose computing device, which may be used to implement gapless media for various formats.

For example, computing device 800 may be used as a server, desktop computer, portable computer, smart phone, special purpose computer, or similar device. In an example basic configuration 802, the computing device 800 may include one or more processors 804 and a system memory 806. A memory bus 808 may be used for communicating between the processor 804 and the system memory 806. The basic configuration 802 is illustrated in FIG. 8 by those components within the inner dashed line.

Depending on the desired configuration, the processor 804 may be of any type, including but not limited to a microprocessor (μP), a microcontroller (μC), a digital signal processor (DSP), or any combination thereof. The processor 804 may include one more levels of caching, such as a level cache memory 812, one or more processor cores 814, and registers 816. The example processor cores 814 may (each) include an arithmetic logic unit (ALU), a floating point unit (FPU), a digital signal processing core (DSP Core), or any combination thereof. An example memory controller 818 may also be used with the processor 804, or in some implementations the memory controller 818 may be an internal part of the processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, a media application 822, and program data 824. The media application 822 may include a media engine 826 to determine if received media is according to a format that includes metadata indicating gap information. If metadata indicating gap information is detected that information may be extracted and used to create a media stream with gap(s) removed. If the received media does not include metadata indicating gap information, heuristics may be employed to estimate and remove gap(s) in the resulting media stream. The media stream may then be saved or played. The program data 824 may include, among other data, samples 828 that may be used to generate gapless media, as described herein.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage interface bus 834. The data storage devices 832 may be one or more removable storage devices 836, one or more non-removable storage devices 838, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 806, the removable storage devices 836 and the non-removable storage devices 838 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 846) to the basic configuration 802 via the bus/interface controller 830. Some of the example output devices 842 include a graphics processing unit 848 and an audio processing unit 850, which may be configured to communicate to various external devices such as a display or speakers via one or more AN ports 852. One or more example peripheral interfaces 844 may include a serial interface controller 854 or a parallel interface controller 856, which may be configured to communicate with external devices such as input devices (for example, keyboard, mouse, pen, voice input device, touch input device, etc.) or other peripheral devices (for example, printer, scanner, etc.) via one or more I/O ports 858. An example communication device 846 includes a network controller 860, which may be arranged to facilitate communications with one or more other computing devices 862 over a network communication link via one or more communication ports 864. The one or more other computing devices 862 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 800 may also be implemented as a part of a general purpose or specialized server, mainframe, or similar computer that includes any of the above functions. The computing device 800 may also be implemented as a personal computer including both laptop computer and non-laptop computer configurations.

Example embodiments may also include methods to provide gapless media for various formats. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

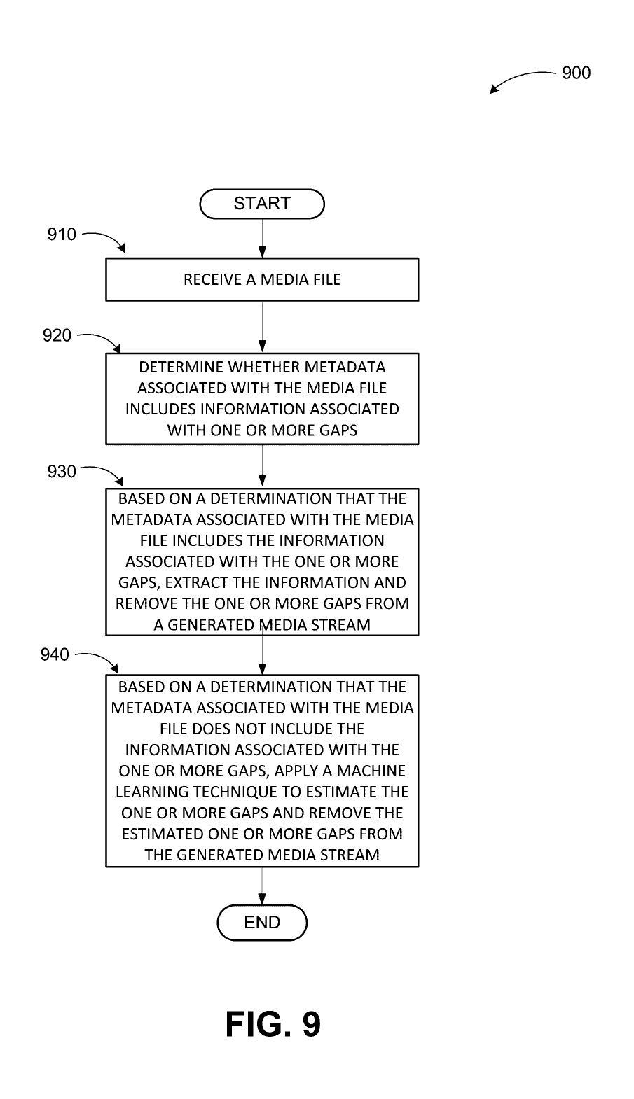

FIG. 9 illustrates a logic flow diagram of a method to provide gapless media for various formats, according to embodiments. Process 900 may be implemented on a computing device such as the computing device 800 or other system.

Process 900 begins with operation 910, where a media file is received. The media file may or may not include metadata that indicates gap information such as encoder delay and padding. At operation 920, a media application or a media engine may determine if metadata associated with the media file includes information associated with one or more gaps.

If metadata associated with the media file includes the information associated with the one or more gaps, the media application may extract the information and remove the one or more gaps from a generated media stream based on the information at operation 930. If metadata associated with the media file does not include the information associated with the one or more gaps, the media application may apply a machine learning technique to estimate the one or more gaps and remove the estimated one or more gaps from the generated media stream at operation 940.

The operations included in process 900 are for illustration purposes. Providing gapless media for various formats may be implemented by similar processes with fewer or additional steps, as well as in different order of operations using the principles described herein.

According to some examples, a means for providing gapless media is described. An example means may include a means for receiving a media file; a means for determining whether metadata associated with the media file includes information associated with one or more gaps; based on a determination that the metadata associated with the media file includes the information associated with the one or more gaps, a means for extracting the information and a means for removing the one or more gaps from a generated media stream. Otherwise, the means may include, based on a determination that the metadata associated with the media file does not include the information associated with the one or more gaps, a means for applying a machine learning technique to estimate the one or more gaps and a means for removing the estimated one or more gaps from the generated media stream; and a means for playing or a means for storing the generated media stream.

According to some examples, a computing device configured to provide gapless media is described. An example computing device may include memory configured to store one or more instructions associated with execution of a media application and one or more processors coupled to the memory and configured to execute the media application. The media application may be configured to receive a media file and determine whether metadata associated with the media file includes information associated with one or more gaps. The media application may also extract the information and remove the one or more gaps from a generated media stream based on a determination that the metadata associated with the media file includes the information associated with the one or more gaps. The media application may further apply a machine learning technique to estimate the one or more gaps and remove the estimated one or more gaps from the generated media stream based on a determination that the metadata associated with the media file does not include the information associated with the one or more gaps.

According to other examples, the media application may be further configured to playback the generated media stream and/or store the generated media stream. The information associated with the one or more gaps may include one or more of an encoder delay and a padding. The information associated with the one or more gaps may be stored as one or more specified bytes in a header of the media file. The machine learning technique may include applying heuristics to estimate the one or more gaps. The media application may be further configured to create a media playback list including audio and/or video media files and bind playlists to a media element for automatic playback.

According to further examples, the media application may be further configured to receive events in response to media sources and media playback items being opened; receive events in response to playback being switched from one media playback item to another; and receive an error event for specific media playback items in a media playback list. The media application may also be configured to configure loop and shuffle on a media playback list or reference media items from one or more of a uniform resource identifier, a stream, and a file.

According to other examples, a method to provide gapless media is described. An example method may include receiving a media file; determining whether metadata associated with the media file includes information associated with one or more gaps; based on a determination that the metadata associated with the media file includes the information associated with the one or more gaps, extracting the information and removing the one or more gaps from a generated media stream. Otherwise, the method may include, based on a determination that the metadata associated with the media file does not include the information associated with the one or more gaps, applying a machine learning technique to estimate the one or more gaps and removing the estimated one or more gaps from the generated media stream; and playing or storing the generated media stream.

According to some examples, the method may further include providing an interface to enable the information associated with the one or more gaps in a non-native media file to be exposed for gap removal and playback on a native media engine. The method may also include providing one or more playback controls on the generated media stream or referencing media items from one or more of a uniform resource identifier, a stream, and a file. A media engine performing the extraction of the information and the removal of the one or more gaps actions may be part of an operating system and may be configured to operate in conjunction with one or more media applications. A media engine performing the extraction of the information and the removal of the one or more gaps actions may also be part of a locally installed media application.

According to further examples, a computer-readable memory device with instructions stored thereon to provide gapless media is described. The instructions may include receiving a media file; determining whether metadata associated with the media file includes information associated with one or more gaps; based on a determination that the metadata associated with the media file includes the information associated with the one or more gaps, extracting the information and removing the one or more gaps from a generated media stream. Otherwise, the instructions may include applying a heuristic based machine learning technique to estimate the one or more gaps and removing the estimated one or more gaps from the generated media stream and one of playing and storing the generated media stream.

According to other examples, the information associated with the one or more gaps may be stored as one or more specified bytes in a header of the media file and may include one or more of an encoder delay and a padding. The instructions may further include creating a media playback list including audio and/or video media files; binding one or more playlists to a media element for automatic playback; configuring loop and shuffle on the media playback list; and setting one or more of a file and a network stream as a source.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device configured to provide gapless media, the computing device comprising:
memory configured to store one or more instructions associated with execution of a media application; and
one or more processors coupled to the memory and configured to execute the media application, the media application configured to:
receive a media file;
determine whether metadata associated with the media file includes information associated with one or more gaps;
based on a determination that the metadata associated with the media file includes the information associated with the one or more gaps,
extract the information, and
remove the one or more gaps from a generated media stream; and
based on a determination that the metadata associated with the media file does not include the information associated with the one or more gaps, apply a machine learning technique to estimate the one or more gaps and remove the estimated one or more gaps from the generated media stream.

2. The computing device of claim 1, wherein the media application is further configured to:
playback the generated media stream.

3. The computing device of claim 1, wherein the media application is further configured to:
store the generated media stream.

4. The computing device of claim 1, wherein the information associated with the one or more gaps includes one or more of an encoder delay and a padding.

5. The computing device of claim 1, wherein the information associated with the one or more gaps is stored as one or more specified bytes in a header of the media file.

6. The computing device of claim 1, wherein the machine learning technique includes applying heuristics to estimate the one or more gaps.

7. The computing device of claim 1, wherein the media application is further configured to:
create a media playback list including audio and/or video media files.

8. The computing device of claim 1, wherein the media application is further configured to:
bind playlists to a media element for automatic playback.

9. The computing device of claim 1, wherein the media application is further configured to:
receive events in response to media sources and media playback items being opened;
receive events in response to playback being switched from one media playback item to another; and
receive an error event for specific media playback items in a media playback list.

10. The computing device of claim 1, wherein the media application is further configured to:
configure loop and shuffle on a media playback list.

11. The computing device of claim 1, wherein the media application is further configured to:
reference media items from one or more of a uniform resource identifier, a stream, and a file.

12. A method to provide gapless media, the method comprising:
receiving a media file;
determining whether metadata associated with the media file includes information associated with one or more gaps;
based on a determination that the metadata associated with the media file includes the information associated with the one or more gaps,
extracting the information, and
removing the one or more gaps from a generated media stream; else
based on a determination that the metadata associated with the media file does not include the information associated with the one or more gaps, applying a machine learning technique to estimate the one or more gaps and removing the estimated one or more gaps from the generated media stream; and
one of playing and storing the generated media stream.

13. The method of claim 12, further comprising:
providing an interface to enable the information associated with the one or more gaps in a non-native media file to be exposed for gap removal and playback on a native media engine.

14. The method of claim 13, further comprising:
providing one or more playback controls on the generated media stream.

15. The method of claim 13, further comprising:
referencing media items from one or more of a uniform resource identifier, a stream, and a file.

16. The method of claim 12, wherein a media engine performing the extraction of the information and the removal of the one or more gaps actions is part of an operating system and is configured to operate in conjunction with one or more media applications.

17. The method of claim 12, wherein a media engine performing the extraction of the information and the removal of the one or more gaps actions is part of a locally installed media application.

18. A computer-readable memory device with instructions stored thereon to provide gapless media, the instructions comprising:
receiving a media file;
determining whether metadata associated with the media file includes information associated with one or more gaps;
based on a determination that the metadata associated with the media file includes the information associated with the one or more gaps,
extracting the information, and
removing the one or more gaps from a generated media stream; else
applying a heuristic based machine learning technique to estimate the one or more gaps and removing the estimated one or more gaps from the generated media stream; and
one of playing and storing the generated media stream.

19. The computer-readable memory device of claim 18, wherein the information associated with the one or more gaps is stored as one or more specified bytes in a header of the media file and includes one or more of an encoder delay and a padding.

20. The computer-readable memory device of claim 18, wherein the instructions further comprise:
creating a media playback list including audio and/or video media files;
binding one or more playlists to a media element for automatic playback;
configuring loop and shuffle on the media playback list; and
setting one or more of a file and a network stream as a source.
